(19) United States
(12) Patent Application Publication
(10) Pub. No.: US 2018/0145957 A1
(43) Pub. Date: May 24, 2018

(54) USER-DEFINED DYNAMIC PASSWORD

(71) Applicant: CA, Inc., New York, NY (US)

(72) Inventors: Krishna Chaithanya Kasibhatla, Hyderabad (IN); M.V. Udai Shankar, Hyderabad (IN)

(21) Appl. No.: 15/358,387

(22) Filed: Nov. 22, 2016

(51) Int. Cl. H04L 29/06

(52) U.S. Cl. CPC H04L 63/068; H04L 63/10; H04L 63/0846

(57) ABSTRACT

In an embodiment, a password management system may include a static password associated with a user ID, and a user-defined function associated with the user ID that generates a dynamic password from one or more parameters and the static password. The function may be reversible, and when a dynamic password is presented, the static password may be generated from the inverse function, the dynamic password, and the parameters. The generated static password may be compared to the static password associated with the user ID to determine if the correct password has been entered.

### BACKGROUND

### Technical Field

This disclosure relates generally to computer security, and, more specifically, to password security.

### Description of the Related Art

Most electronically-accessible accounts (e.g. accounts accessible over a network such as the Internet or any wide area network or local area network) are secured with a password. A given user can create an account on a server, and the account can be identified by a user identifier (ID) created by the user or associated with a user (e.g. an email address). A password can further secure the account. Typically, the user creates the password as well (although the user may be required to follow minimum guidelines enforced by the website). If the user is in a secure location such as the user's home or other private property, or in the user's work place, the password is reasonably safe from public observation and thus provides a reasonable amount of security for the account.

Access to accounts in public spaces has become wide-spread, with the high availability of (often free) wifi in public places as well as the use of mobile devices such as smart phones, tablets, laptops, etc. which have networking capabilities. Publically available computers in public places such as libraries, hotel lobbies, etc. are also widely available. When a user enters his/her password in a public space, the password is subject to observation by third parties (often referred to as snooping attacks). Observation may be as simple as looking over the user's shoulder, observing from nearby, closed circuit camera monitoring, keyboard readers/loggers installed on public devices, etc. If the user's password is compromised, the third party may later be able to access the user's account. If the account is a bank account, for example, money could be stolen. If the account includes personal information, identity theft can be an issue.

One attempt to mitigate the issue of password security includes the use of dynamic passwords. The user can create a password for an account when in a secure location, and then dynamic passwords can be created from the password and a set of rules that are typically server-specific. It is difficult for the user to remember the rules and properly generate the dynamic password, however, limiting the usefulness of the mechanism.

### SUMMARY

In an embodiment, a password management system may include a static password associated with a user ID, and a user-defined function associated with the user ID that generates a dynamic password from one or more parameters and the static password. As implied by the name, the user-defined function may be defined by the user when dynamic password is enabled for the user ID. The function may be reversible, and when a dynamic password is presented, the static password may be generated from the inverse function, the dynamic password, and the parameters. The generated static password may be compared to the static password associated with the user ID to determine if the correct password has been entered.

In an embodiment, the user ID may be presented to a server that controls the log in process. If dynamic password is enabled for the user ID, the server may generate one or more of the parameters and transmit them to the client from which the user is attempting to log in. The user may determine the dynamic password based on the parameters, and supply the dynamic password. The server may use the parameters and inverse function to compute the corresponding static password to be verified against the static password stored by the server.

In an embodiment, the user may have the option of logging in with either the static or the dynamic password. The server may first attempt to verify the received password against the stored password. If the password is verified, the user is permitted access to the user account controlled by the password. If the password is not verified, the server may use the inverse function to compute the static password from the received password, and may check the computed password against the stored password. In the password is verified, the user is permitted access. If the password is not verified, the user is denied access.

### BRIEF DESCRIPTION OF THE DRAWINGS

FIG. 1 is a block diagram illustrating an embodiment of a password control system.

FIG. 2 is a flowchart illustrating an embodiment of password creation.

FIG. 3 is a flowchart illustrating an embodiment of password authentication.

FIG. 4 is a block diagram illustrating an exemplary computer system.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “risk assessment server that is configured to determine whether to authenticate the client computer system” is intended to cover, for example, a computer system that has circuitry that performs this function during operation, even if the computer system in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

### DETAILED DESCRIPTION

In an embodiment, a password management system may provide password authentication for user log ins to various systems. The password management system may be part of an application server or other computer or network of computers on which a user has an account, or may be a separate system that controls log in to the system on which the user has an account. The account may be secured by the user ID, which identifies the user, and the password. More particularly, the user may create a static password when creating the account (or when changing the password, in some embodiments). The static password may be used at any time by the user to log in. However, the static password is the same each time it is entered. Accordingly, if the static password is observed, the corresponding account may be compromised. The static password may be used, e.g., if the user is a secure environment in which observation of the password is highly unlikely.

If the user is in a public place, a dynamic password may be used. The dynamic password may be generated based on the static password and one or more parameters. The user may define the function, and thus may be aware of the algorithm that the function employs. The function may be reversible. A reversible function is a function in which, given an output of the function, the input to the function may be determined. That is, each set of one or more inputs (and possibly state in the function itself), results in a unique output. A reversible function may have in inverse (which takes a value and generates the input to the original function that would produce the value).

In one embodiment, the function may take one or more parameters in addition to the input password. The parameters may be selected by the user as part of defining the function. The parameters may be any values, and may be generated in any fashion, but may change from log in to log in. Thus, the dynamic password may often be different from log in to log in. If the dynamic password is observed, it is highly unlikely to work the next time as a log in password.

As mentioned above, any parameter generated in any fashion may be used. For example, the parameters may be pseudo-randomly generated by the password management system and may be provided to the user (e.g. on a client system used by the user) so that the user may generate the dynamic password. Other parameters may be any deterministically-generated value. For example, the parameters may include environmental parameters. The environmental parameters may include any data that is generated dependent on some aspect of the environment surrounding the user. For example, the environmental parameters may include location (e.g. specific physical location such as longitude and latitude or global positioning system (GPS) coordinates, or symbolic location such as home or work). The environmental parameters may include day of the week, month or year and/or time of day. Environmental parameters may include temperature or other weather variables, etc.

In an embodiment, the user-specified function may actually implement multiple functions. The particular function used for a given log in may be determined from one or more of the parameters. For example, a different function may be used at work versus at home. Any parameter may be used to select among multiple functions.

The generated parameters may also be retained by the password management system. When the dynamic password is supplied, the password management system may apply the inverse function corresponding to the user ID to the dynamic password and the parameters. The result of the inverse function may be another password, which may match the static password associated with the user ID. If the password matches the static password, the task may be finished and user may be permitted access to the account. If the password does not match the static password, access may be denied.

Because the user has defined the function, the user is familiar with the function. The function may be a relatively simple function that the user remembers and applies based on the parameters. The function may be a more complex function and the user may have an application to execute to produce the dynamic password. However the dynamic password is generated, the user may not type in the static password in order to generate the dynamic password. Instead, it may be stored in the function or in a location known to the function (e.g. a file for which the pathname is known to the function). Thus, the static password need not be revealed in an observable fashion.

Because the corresponding static password is generated by applying the inverse function to the received, the static password maintained by the password management may be stored in hashed form (e.g. encrypted or otherwise modified from its original value). In this manner, the static password need not be actually viewable in the password management system, increasing security of the static password.

Generally, the user account may be any combination of data that belongs to the user, a profile of one or more apps that the user has access to, etc. Exemplary accounts may include bank accounts or other financial accounts, subscriptions to online content such as news outlets, email accounts, an account on an application server that gives the user rights to use one or more applications on the application server, etc.

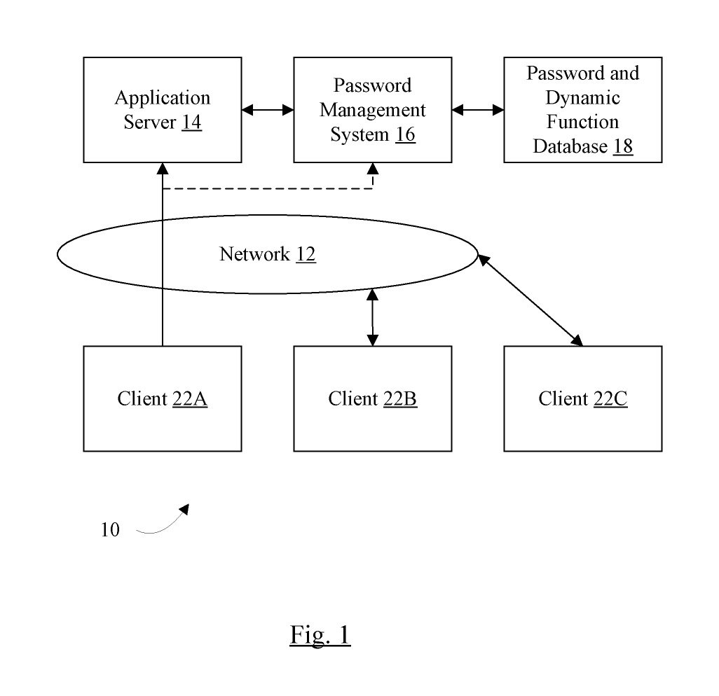

Turning now to FIG. 1, a block diagram of one embodiment of an authentication system 10 is depicted. In the illustrated embodiment, the authentication system 10 includes a network 12, an application server computer system 14, a password management computer system 16, and one or more client computer systems 22A-22C. The password management computer system 16 may include or be coupled to a password and dynamic function database 18. In some embodiments, the password and dynamic function database 18 may be on one or more different computer systems from the password management system 16. The various computer systems in FIG. 1 may be more briefly referred to without the words “computer system” (e.g. application server 14, password management system 16, etc.). Alternatively, the various computer systems may be more generically viewed as software executable on a computer system, where the particular computer system may execute more than one of the various software components, or a distributed or federated group of computer systems.

The network 12 may be a computer network of any type. For example, the network 12 may be a private network having restricted access for external devices. For example, in some embodiments, the network 12 may a local area network (LAN) having a gateway coupling the LAN to the Internet. The gateway may implement a firewall that restricts which incoming traffic is permitted to enter the network 12 as well as restrict the destinations in the network 12 that are permitted to receive the traffic. Alternatively, the network 12 may be a wide area network (WAN) which may be private or public (e.g. the Internet). The network 12 may include wireless networks, wired networks, or any combination thereof.

The application server 14, in one embodiment, may be a computer system that executes one or more applications which may be used by users on the client computer systems 22A-22C. For example, the application server 14 may include an application to provide access to a user's account with a business with which the user has a relationship (e.g. a bank or other financial institution holding the user's bank accounts or other financial accounts, an information service such as a newspaper or other news source, various “stores” from which users may purchase merchandise, etc.). As another example, the applications may include various software applications that the user may execute to accomplish tasks (e.g. productivity software such as word processing software, spreadsheet software, presentation software, email management software, etc.). The applications may be available to the user by subscription, in a software as a service model, for example.

Generally, the application server 14 may authenticate the user prior to providing the user access to the applications, accounts, etc. The authentication process may be a mechanism by which the user identifies himself/herself to the satisfaction of the application server 14 (e.g. the user appears to in fact be the user and not a third party such as a hacker, identity thief, etc.). The authentication process may include the user presenting a user ID and password. Additional information may or may not be used in the authentication process. A user ID, as used herein, is any identifier that is assigned to the user and identifies the user. The user ID may be a user name created by the user when initially registering with the application server 14, an email address used by the user, etc. The password may also be created by the user, and may be changed by the user as desired or in compliance with application server requirements for periodically changing the password. A password reset may also be requested by a user if the user forgets his/her password.

The password management system 16 may be used to determine if the password presented by a user is the correct password for that user ID and for the application server 14. The application server 14 may transmit a request including at least the user ID, and the password management system 16 may transmit a prompt for a password to the client system 22A-22C from which the user is attempting to log in (e.g. client 22A in FIG. 1). The password may be a static password if dynamic passwords are not enabled or the user chooses to enter a static password. If dynamic password is enabled, the password management system 16 may generate one or more parameters and transmit the parameters with the password prompt to the client 22A-22C from which the user is attempting to log in (e.g. client 22A in FIG. 1 as shown). The user ID and the password may be communicated directly between the client 22A-22C and the password management system 16 over the network 12, or may be communicated through the application server 14, in various embodiments. If the password is correct, the password management system 16 may message the application server 14 to indicate that the user may be granted access to the user account associated with the user ID. If the password is incorrect, the password management system 16 may re-prompt for the password, possibly including a new set of parameters.

The password and dynamic function database 18 may store various user IDs (e.g. as a key field for searching), static passwords, and user-defined dynamic password generation functions. In an embodiment, the inverse function is stored. In another embodiment, both the inverse function and the user-defined function are stored. In an embodiment, the static password is stored in hashed form (e.g. encrypted or otherwise modified). In this manner, the actual static password is not in the database 18 and thus security is increased by not exposing the static password in the database. Since the user has the option of entering the static password even if dynamic passwords are enabled, the received password may be hashed using the same hashing operation that is applied to the static password and the hashed result may be compared to the stored hashed password. In an embodiment, checking for a static password match is performed first, prior to evaluating the inverse function. Generally, as used herein, a database refers to any organized data storage structure. For example, a database may be a lookup table (indexed by user ID, for example), a list, relational database, document-oriented data structure, NoSQL form (e.g. key, value pairs), etc.

The client computer systems 22A-22C, in one embodiment, may be computer systems accessible to the users. A given client computer system 22A-22C may be dedicated to the user, owned by the user, in possession of the user, publically available but currently used by the user when attempting to log in, etc. The client computer systems 22A-22C may be any type of computing device (desktop, server, laptop, work station, tablet computer, smart phone, etc.).

While different computer systems have been shown in FIG. 1 for the application server 14, the password management system 16, and the database 18, one or more of the above may be combined onto a server computer system or other computer system. Alternatively, the combination may be distributed over multiple computer systems in a distributed or federated computing model. One or more of the above may be local to the client computer systems 22A-22C, in some embodiments. Any combination of computer systems and local (to the client computer system 22A-22C) or remote (on a server) execution may be used in various embodiments.

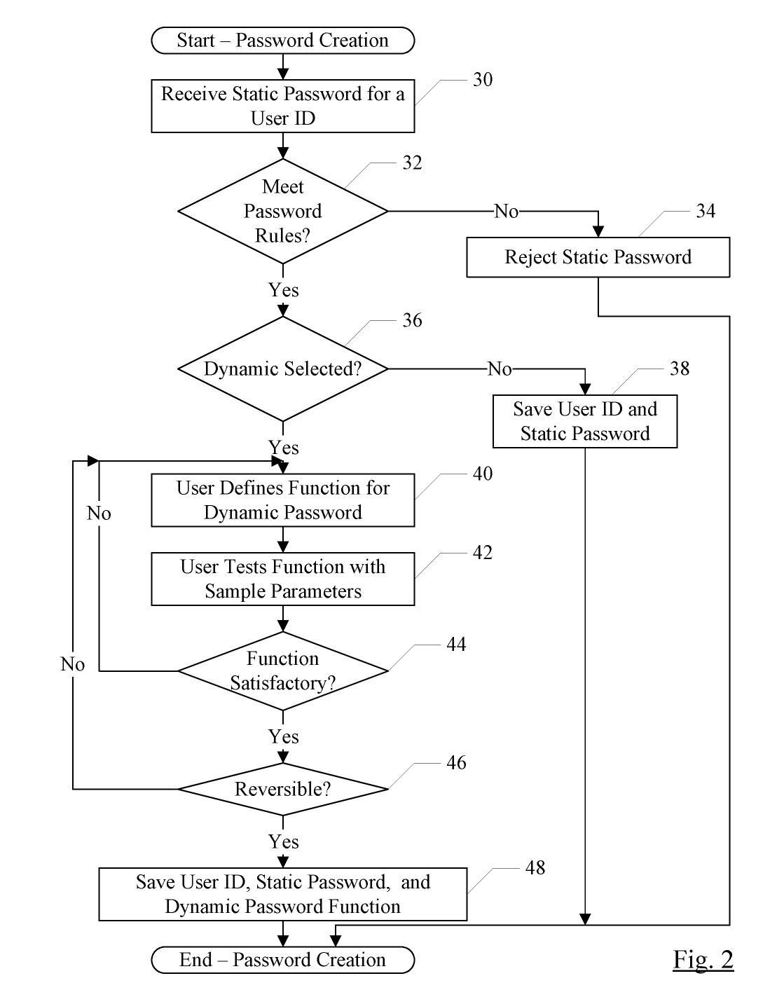

Turning now to FIG. 2, a flowchart is shown illustrating certain operations of one embodiment of the password management system 16. While the blocks are shown in a particular order for ease of understanding, other orders may be used. The password management system 16 may include instructions which, when executed on a computer system, cause the computer to perform the operations illustrated in the flowchart.

The flowchart of FIG. 2 may illustrate operation of the password management system 16 when a password is initially created for a user account. Similar operation may be performed at any time the password is changed (e.g. changed by the user voluntarily, changed in response to password policies requiring change at a certain frequency, changed due to password reset when a password cannot be recalled by the user, etc.).

The password management system 16 may receive a user ID and the static password created by the user (block 30). In some embodiments, the password management system 16 may determine if the password meets a set of password rules required by the system 16 or a given application server 14 (decision block 32) and, if not (decision block 32, “no” leg), the password management system 16 may reject the static password and request that the user enter a new password in conformance with the password rules (block 34). In other embodiments, the password rules may be enforced by the application server 14 prior to sending the user ID and password to the password management system 14.

If the user has not enabled dynamic passwords for the account (decision block 36, “no” leg), the password management system may save the user ID and static password in the database 18 (block 38). As mentioned previously, the static password may be hashed and stored in hashed form in the database 18. In addition, an indication that dynamic password is not enabled for this user ID may be stored.

On the other hand, if the user enables dynamic passwords (decision block 36, “yes” leg), the password management system 16 may interact with the user to define the function for the dynamic password (block 40). For example, the password management system 16 may provide an interface for the user to input code defining the function, or a higher level interface where the flow and logic of operations are defined and the corresponding code is automatically generated. The code may be instructions to be executed, or may define the operation in pseudo-code that may be interpreted by the password management system to perform the function. The user may test the function with one or more sample parameters (block 42) and if the function is satisfactory (decision block 44, “yes” leg) and reversible (decision block 46, “yes” leg), the password management system 16 may save the user ID, the static password, and the dynamic password function in the database 18 (block 48). The static password may be stored in hashed form, as mentioned above. Rather than storing the dynamic password function, or in addition to storing the function, the password management system 16 may generate the inverse of the function for generating the static password from a dynamic password supplied by the user. An indication that dynamic passwords are enabled may also be stored. Thus, an entry in the database 18 may include user ID, hashed static password, dynamic password enable/disable, and dynamic password function/inverse function field. The dynamic password function field may, in other embodiments, be a pointer to a location storing the dynamic password function/inverse. If either the function is not satisfactory (decision block 44, “no” leg) or not reversible (decision block 46, “no” leg), the password management system may continue interacting with the user to define the dynamic password function (blocks 40 and 42).

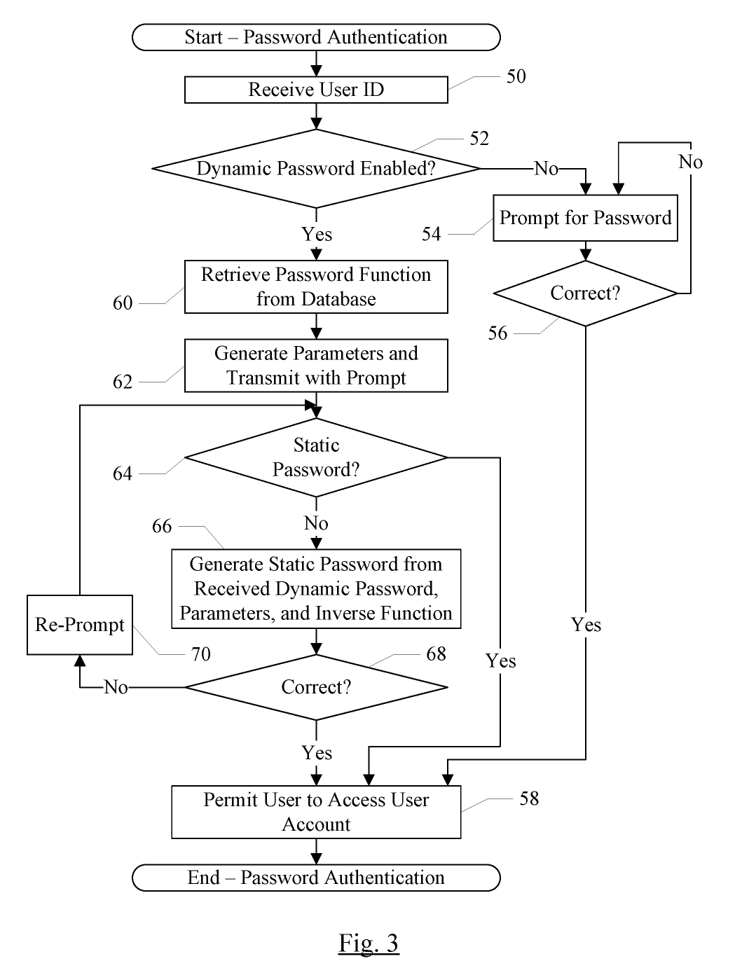

FIG. 3 is flowchart illustrating operation of certain operations of one embodiment of the password management system 16 when a user attempts to log in to a user account, to authenticate the user. While the blocks are shown in a particular order for ease of understanding, other orders may be used. The password management system 16 may include instructions which, when executed on a computer system, cause the computer to perform the operations illustrated in the flowchart.

The password management system 16 may receive a user ID for a user who is attempting to log in (block 50). The password management system 16 may access the password and dynamic function database 18 to determine if dynamic password is enabled for the user ID. If not (decision block 52, “no” leg), the password management system 16 may transmit a prompt for the password to the client system 22A-22C that sent the user ID (block 54). The received password may be hashed and compared to the stored password in the static password field of the entry. If the passwords match (decision block 56, “yes” leg), the user may be permitted access to the user account (block 58). If the passwords do not match (decision block 56, “no” leg), the password management system 16 may re-prompt the user for the password (block 54). At some point (e.g. after a number of failed attempts to log in), the password management system 16 may terminate the log in attempt and block the user (temporarily, or until unblocked by an administrator, for example) or take other security steps with respect to the user.

If dynamic password is enabled for the user ID (decision block 52, “yes” leg), the password management system 16 may retrieve the password function from the database 18 (block 60). The password management system 16 may generate one or more parameters for the function (block 62) and may transmit the parameters with the password prompt. The parameters may also be retained by the password management system 14. The user may transmit a password. In response to receiving a password, the password management system 16 may first check the received password directly against the stored password (decision block 64). The user may have opted to enter the static password (e.g. the user is in a secure location). If so, then the received password will match the stored password (assuming the user entered it correctly). The password management system may hash the received password and compare to the stored hashed password. If correct (decision block 64, “yes” leg), the static password has been entered and the user may be permitted to access the user account (block 58). If incorrect (decision block 64, “no” leg), the password may be a dynamic password. The password management system may generate a static password from the dynamic password, the parameters, and the inverse of the user-defined function for the dynamic password (block 66). The password management system 16 may hash the result of the inverse function and compare it to the hashed static password associated with the user ID from the database 16. If they match (decision block 68, “yes” leg), the user may be permitted to access the user account (block 58). If not (decision block 68, “no” leg), the user may be re-prompted for the password (block 70). In some embodiments, new parameters may be generated and transmitted with the re-prompt. In other embodiments, the same parameters may be used. As with the discussion above, there may be a limit to the number of attempts that are permitted before the password management system 16 terminates the log in attempt.

### Exemplary Computer System

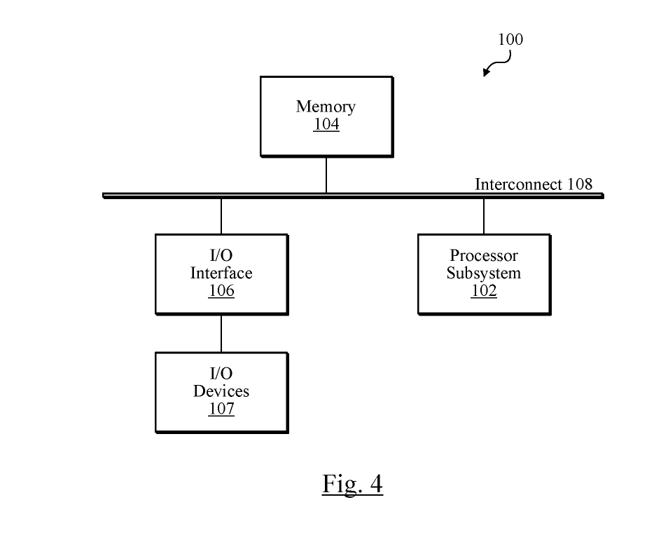

Turning now to FIG. 4, a block diagram of an exemplary computer system 100, which may implement one or more computer systems 14, 16, and/or 22A-22C, is depicted. Computer system 100 includes a processor subsystem 102 that is coupled to a system memory 104 and I/O interfaces(s) 106 via an interconnect 108 (e.g., a system bus). I/O interface(s) 106 is coupled to one or more I/O devices 107. Computer system 100 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 100 is shown in FIG. 4 for convenience, system 100 may also be implemented as two or more computer systems operating together.

Processor subsystem 102 may include one or more processors or processing units. In various embodiments of computer system 100, multiple instances of processor subsystem 102 may be coupled to interconnect 108. In various embodiments, processor subsystem 102 (or each processor unit within 102) may contain a cache or other form of on-board memory.

System memory 104 is usable store program instructions executable by processor subsystem 102 to cause system 100 perform various operations described herein. System memory 104 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 100 is not limited to primary storage such as memory 104. Rather, computer system 100 may also include other forms of storage such as cache memory in processor subsystem 102 and secondary storage on I/O Devices 107 (e.g., a hard drive, storage array, etc.). In some embodiments, these other forms of storage may also store program instructions executable by processor subsystem 102. In some embodiments, memory 104 may include software for application server 14, password management system 16, and/or client systems 22A-22C.

I/O interfaces 106 may be any of various types of interfaces configured to couple to and communicate with other devices, according to various embodiments. In one embodiment, I/O interface 106 is a bridge chip (e.g., Southbridge) from a front-side to one or more back-side buses. I/O interfaces 106 may be coupled to one or more I/O devices 107 via one or more corresponding buses or other interfaces. Examples of I/O devices 107 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 100 is coupled to a network via a network interface device 107 (e.g., configured to communicate over WiFi, Bluetooth, Ethernet, etc.).

One or more of the system memory 104 components and/or the I/O devices 107 may include a computer accessible storage medium storing program instructions forming the software described herein. The program instructions may be executable on a computer to implement the operation described above for various software modules. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, or Flash memory. The storage media may be physically included within the computer to which the storage media provides instructions/data. Alternatively, the storage media may be connected to the computer. For example, the storage media may be connected to the computer over a network or wireless link, such as network attached storage. The storage media may be connected through a peripheral interface such as the Universal Serial Bus (USB). Generally, the computer accessible storage medium may store data in a non-transitory manner, where non-transitory in this context may refer to not transmitting the instructions/data on a signal. For example, non-transitory storage may be volatile (and may lose the stored instructions/data in response to a power down) or non-volatile. A carrier medium may include computer accessible storage media as well as transmission media such as wired or wireless transmission.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory computer-readable storage medium having stored thereon program instructions that are computer-executable to perform operations comprising:
receiving, at a computer system, a first password corresponding to a user identifier, wherein the user identifier specifies a user;
determining, by the computer system, that a dynamic password is enabled for the user identifier, wherein the dynamic password is generated from a second password and one or more parameters according to a user-specified function, wherein the dynamic password for the user identifier in a first log in instance is different from the dynamic password for the user identifier in a second log in instance;
generating, by the computer system, a third password from the first password, the one or more parameters, and an inverse of the user-specified function;
determining whether or not the third password matches the second password; and
permitting the user to access a user account associated with the password responsive to the third password matching the second password.

2. The computer-readable storage medium of claim 1, wherein the program instructions that are computer executable to perform determining whether or not the third password matches the second password including program instructions that are computer executable to perform:
hashing the third password to generate a hashed result; and
comparing the hashed result to a hashed second password associated with the user identifier.

3. The computer-readable storage medium of claim 1, wherein the program instructions are computer executable to perform:
determining whether or not the first password matches the second password.

4. The computer-readable storage medium of claim 3, wherein determining whether or not the first password matches the second password is performed prior to generating the third password and determining whether or not the third password matches the second password.

5. The computer-readable storage medium of claim 1, wherein the program instructions are computer executable to perform:
receiving, at the computer system a fourth password associated with a second user identifier;
determining, by the computer system, that the dynamic password is not enabled for the second user identifier; and
determining, by the computer system responsive to determining that the dynamic password is not enabled for the second user identifier, whether or not the fourth password matches a fifth password at the computer system and associated with the second user identifier.

6. The computer-readable storage medium of claim 1, wherein the user-specified function is specified by the user at a time that the first password is changed by the user.

7. The computer-readable storage medium of claim 1, wherein the program instructions are computer executable to perform:
ensuring that the user-specified function is reversible; and
storing the reversible user-specified function and a representation of the second password in a database.

8. The computer-readable storage medium of claim 1, wherein the program instructions are computer executable to perform:
receiving, in the computer system, the user identifier;
generating at least a first parameter of the one or more parameters by the computer system in response to receiving the user identifier; and
transmitting at least the first parameter from the computer system to a second computer system used by the user.

9. The computer-readable storage medium of claim 8, wherein the first parameter is generated deterministically according to a user definition of the first parameter.

10. The computer-readable storage medium of claim 1, wherein at least one of the one or more parameters is an environmental parameter determined by a user's environment at a time that the user identifier is presented to the computer system for log in.

11. The computer-readable storage medium of claim 10, wherein the environmental parameter includes a location of the user.

12. The computer-readable storage medium of claim 10, wherein the environmental parameter includes a time of day.

13. The computer-readable storage medium of claim 10, wherein the environmental parameter includes a day of the week.

14. The computer-readable storage medium of claim 1, wherein the user-specified function includes a plurality of functions, and wherein one of the plurality of functions is selected dependent at least one of the one or more parameters.

15. A non-transitory computer-readable storage medium having stored thereon program instructions that are computer-executable to perform operations comprising:
receiving, at a computer system, a first password associated with a user identifier, wherein the user identifier identifies a user;
determining, by the computer system, if the first password matches a second password associated with the user identifier by the computer system;
responsive to determining that the first password does not match the second password, generating, by the computer system, a third password from the first password in accordance with a user-specified function and one or more parameters;
determining, by the computer system, if the third password matches the second password; and
permitting the user to access a user account associated with the password responsive to the third password matching the second password.

16. The computer readable storage medium of claim 15 wherein generating the third password from the first password in accordance with the user-specified function and the one or more parameters comprises evaluating an inverse of the user-specified function over the one or more parameters and the first password.

17. The computer readable storage medium of claim 15, wherein at least one of the one or more parameters is an environmental parameter determined by a user's environment at a time that the user identifier is presented to the computer system for log in.

18. The computer-readable storage medium of claim 17, wherein the user-specified function includes a plurality of functions, and wherein one of the plurality of functions is selected dependent on the environmental parameter.

19. A method comprising:
receiving, at a computer system, a first password corresponding to a user identifier, wherein the user identifier specifies a user;
determining, by the computer system, that a dynamic password is enabled for the user identifier, wherein the dynamic password is generated from a second password and one or more parameters according to a user-specified function, wherein the dynamic password for the user identifier in a first log in instance is different from the dynamic password for the user identifier in a second log in instance;
generating, by the computer system, a third password from the first password, the one or more parameters, and an inverse of the user-specified function;
determining whether or not the third password matches the second password; and
permitting the user to access a user account associated with the password responsive to the third password matching the second password.

20. The method of claim 19, further comprising:
receiving, at the computer system a fourth password associated with a second user identifier;
determining, by the computer system, that the dynamic password is not enabled for the second user identifier;
determining, by the computer system responsive to determining that the dynamic password is not enabled for the second user identifier, whether or not the fourth password matches a fifth password at the computer system and associated with the second user identifier; and
responsive to determining that the fourth password does not match the fifth password, preventing, by the computer system, user access to the user account.
